(19) United States
(12) Patent Application Publication
(10) Pub. No.: US 2022/0301054 A1
(43) Pub. Date: Sep. 22, 2022

(54) BLOCK BIDDING METHOD AND SYSTEM FOR PROMOTING CLEAN ENERGY CONSUMPTION BASED ON THE POWER TRADING PLATFORM

(71) Applicants: Beijing Kedong Electric Power Control System Co., Ltd., BEIJING (CN); Beijing Electric Power Trading Center Co., Ltd, BEIJING (CN)

(72) Inventors: Lei WANG, BEIJING (CN); Kai XIE, BEIJING (CN); Yali ZHANG, BEIJING (CN); Wujun DONG, BEIJING (CN); Honghai TANG, BEIJING (CN); Ning YANG, BEIJING (CN); Hao TAN, BEIJING (CN); Liang XU, BEIJING (CN); Nan KANG, BEIJING (CN); Peiyu XI, BEIJING (CN); Haining WANG, BEIJING (CN); Shijie JI, BEIJING (CN); Qingbo WANG, BEIJING (CN); Chuncheng GAO, BEIJING (CN); Yin FANG, BEIJING (CN); Shuhong SHI, BEIJING (CN); Mingzhu YUAN, BEIJING (CN); Qian ZHANG, BEIJING (CN); Wentao LV, BEIJING (CN); Jingwei LV, BEIJING (CN); Wanli HU, BEIJING (CN); Ziyang BAI, BEIJING (CN); Junliang LV, BEIJING (CN); Jincheng ZHANG, BEIJING (CN); Xian ZHAO, BEIJING (CN); Xin CHANG, BEIJING (CN); Shulu WAN, BEIJING (CN); Shoubao LI, BEIJING (CN); Ruixiao LI, BEIJING (CN); Ying XUE, BEIJING (CN); Xuan YIN, BEIJING (CN)

(21) Appl. No.: 17/243,069

(22) Filed: Apr. 28, 2021

(30) Foreign Application Priority Data
Mar. 18, 2021 (CN) 202110289977.X

(51) Int. Cl. G06Q 40/04; G06Q 50/06; G06Q 10/04; G06N 5/04; G06N 7/00; H02J 3/00

(52) U.S. Cl. CPC G06Q 40/04; G06Q 50/06; G06Q 10/04; G06N 5/04; G06N 7/00; H02J 3/008

(57) ABSTRACT

The invention relates to a block bidding method and system for promoting clean energy consumption based on the power trading platform. The block bidding method includes the following steps: dividing the time slots for clean energy units to participate in power trading; predicting the typical monthly power generation curve of clean energy units; decomposing the signed annual power contract of clean energy units into months; determining the monthly trading declaration curve of clean energy units; determining the monthly trading declaration curve of clean energy units; determining the time-slot declaration price of clean energy units; realizing the trading clearing by the power trading platform in accordance with the principle of “high-low matching”.

### CROSS REFERENCES TO RELATED APPLICATIONS

The present application claims foreign priority of Chinese Patent Application No. 202110289977.X, filed on Mar. 18, 2021 in the China National Intellectual Property Administration, the disclosures of all of which are hereby incorporated by reference.

### TECHNICAL FIELD

The present invention belongs to the technical field of power trading and relates to the method and system of power trading platform bidding clearing in time, especially a block bidding method and system for promoting clean energy consumption based on the power trading platform.

### BACKGROUND

Accelerating the development and application of a new generation of power trading platform is an inevitable requirement to deepen the construction of the national unified power market and is also an important measure to promote the large-scale, long-distance allocation and consumption of clean energy and accelerate the power industry's “carbon peaking” and “carbon neutral”. Due to the intermittent nature of wind power, photovoltaic and other clean energy output, it is difficult to form an effective market force and competitiveness in power market transactions, which is not conducive to the consumption of clean energy.

Therefore, how to propose a block bidding method for promoting clean energy consumption based on the power trading platform, so that it can achieve the purpose of promoting the consumption of clean energy is a technical problem to be solved by the technical person in the field.

After searching, no prior art disclosures identical or similar to the present invention were found.

### DESCRIPTION OF THE INVENTION

The purpose of the present invention is to overcome the shortcomings of the prior technology and propose a method and system for promoting clean energy consumption based on the power trading platform, which can improve the capacity of clean energy consumption.

The present invention solves its practical problems by adopting the following technical solutions to achieve.

A block bidding method for promoting clean energy consumption based on the power trading platform, comprising the steps of:

Step 1. dividing clean energy units to participate in power trading periods.

Step 2. collecting data on historical trading data and contracted electricity of clean energy units and predicting typical monthly electricity generation curves of clean energy units.

Step 3. decomposing the signed annual power contracts of clean energy units into months according to the annual typical curves of clean energy units.

Step 4. determining the monthly transaction declaration curve of clean energy units based on the typical monthly curve of clean energy units.

Step 5. determining the declared power of clean energy units for trading in time slots.

Step 6. Determine the declared electricity price of clean energy units over time, taking into account the characteristics of clean energy output.

Step 7. Combining the declared data of users on the transferee side and the declared data of conventional units on the transferee side, the power trading platform will realize the transaction clearing by time slots according to the principle of “high and low matching”.

Furthermore, the data collected from the clean energy units in step 2 includes the amount of electricity traded, the level of electricity traded, and the amount of electricity contracted by the clean energy units in the year.

Moreover, the specific method of step 3 is: generating the annual clean energy unit typical curve through the historical annual renewable energy output, decomposing the clean energy annual power contract to monthly according to the annual typical curve, and forming the traded power for that month, with the calculation formula as shown in formula (1).

$${q}_{j} = {Q}_{year} \cdot \frac{{q}_{o\_j}}{{{\sum }_{j = 1}}^{12} {q}_{o\_j}} \qquad ( 1 )$$

Where, q^{j} is the decomposition to electricity in month j; Q_{year} is the total annual volume of contract; q_{o_j} is the generation capacity of typical curve in month j.

Further, the particular step of step 4 comprises:

(1) Calculation of clean energy unit output coefficients for each time point based on historical data.

The monthly power output coefficient by time period for the ith time point is calculated as shown in Equation (2):

$${w}_{i} = \frac{{\sum }_{i = 1}^{N} ( \frac{{p}_{i\_n}}{{P}_{i\_max}} )}{N} \qquad 2 )$$

wᵢ is the power factor of the clean energy unit; N is the number of historical data sets at time i; p_{i_n} is the power situation at time i of the nth set; P_{i_max} is the power maximum at time i of all sets.

(2) Through the existing generation power forecasting technology, forecasting the generation capacity of clean energy units for this month, and then subtracting the annual contract decomposition in step 3, which is the scale of clean energy unit output to be traded in this month, and then product the clean energy unit output coefficient with the scale of clean energy unit output for the month to obtain the typical curve of clean energy units for the month; its calculation formula is shown in equation (3).

$${P}_{i} = P \cdot \frac{{w}_{i}}{{\sum }_{i = 1}^{I} {w}_{i}} \qquad ( 3 )$$

Where, Pᵢ is the typical curve power value at time point i after decomposition of clean energy; P is the total installed capacity of clean energy units; I is the total number of time points.

(3) After generating the monthly typical curve of the clean energy unit, corresponding to the output of the monthly typical curve in each trading period, the monthly trading declaration curve to be completed for the clean energy unit is obtained. Further, specific steps of step 5 include:

(1) First calculate the clean energy trading power under the trading session as in equation (4).

$${q}_{t} = {\sum }_{i ∉} {P}_{i} \qquad ( 4 )$$

Where,

$$Q = {\sum }_{t = 1}^{T} {q}_{t} ;$$

T is the number of trading periods; qₜ is the clean energy trading power under the periods.

(2) Dividing the traded electricity into two parts as the regular part and as the incentive part, it has the relationship as shown in equation (5).

qₜ=aₜ+bₜ (5)

(3) Constraint function equation (6) is established based on the collected user transaction data over time.

$$α = \frac{{a}_{t}}{{u}_{t}} \qquad ( 6 )$$

where a is the conventional market share of clean energy power, which is shown as a constant in the same month, and can be calculated by month according to the clean energy power generation in that month, and the market share of each time period in the same month remains consistent; uₜ is the market power demand of the customer side in time period t.

(4) Based on Eqs. (5) and (6), the values of conventional and incentive power for clean energy units corresponding to different sub-periods can be solved.

Moreover, the calculation method of th step 6 is divided into two price strategies, as shown in Eqs. (7) and (8).

Pₐ=ΣPₘₐᵣₖₑₜ (7)

P_{b}π•ΣPₘₐᵣₖₑₜ (8)

Where, P_{a_t} is the regular power tariff; P_{b_t} is the incentive power tariff; p_{market_t} is the average market price; σ is the floating point; π is the price reduction factor, 0<π<1.

And, the specific method of step 7 is.

According to the pre-determined division of load peak and valley times, the transaction is cleared separately, and the transaction is cleared by the offer or is ranked according to the declared price, and the lower price is given priority to clear the transaction; when the price is the same, the clean energy unit is given priority over the traditional thermal power unit according to the principle of the cleanliness of electricity.

An electricity trading platform for promoting clean consumption, including: parameter setting module, time-slot data declaration module, time-slot transaction clearing module and transaction verification and output module.

The mentioned parameter setting module is mainly used to set relevant parameters, such as annual contract power share, peak and trough time division, price reduction coefficient, market share of clean energy units, etc., and the parameters are set by market participants or trading centers.

The mentioned time-slot data declaration module is used for market participants to declare time-slot electricity and tariff data, and to complete the declaration of electricity trading data in conjunction with the enterprises' own reality.

Accordingly, this module is connected with parameter setting module and time-sharing data declaration module, and can receive relevant parameters and transaction declaration data, and complete market clearing by time slots according to the set peak and valley trading time slots and get the clearing results by time slots.

Accordingly, transaction verification and output module is used to carry out the safety verification of power transactions and output the market transaction clearing results that pass the safety verification.

Further, the time-slot data declaration module described further comprises a trading time slot division module for dividing the clean energy units' participation in power trading time slots, an electricity trading history transaction data collection module for collecting electricity trading history transaction data, including the amount of electricity traded, the level of electricity traded and the amount of electricity in the annual contract that has been signed by the clean energy units.

Annual contract decomposition module for decomposing the annual power contracts of clean energy units into months.

Monthly transaction declaration curve generation module used to generate monthly transaction declaration curves for clean energy units.

Time-slot declaration module, which is used to calculate the time-slot electricity of clean energy units and determine the timeslot declared electricity of clean energy units, taking into account the actual situation of the enterprises themselves.

The module for calculating the block tariff of clean energy units and determining the block tariff of clean energy units, taking into account the actual situation of enterprises.

Advantages and beneficial effects of the present invention.

With the purpose of promoting clean energy consumption, the present invention takes into account the characteristics of split-time trading bidding such as load peak and valley, and proposes a block bidding method and system for promoting clean energy consumption based on the power trading platform. By formulating a reasonable bidding method for clean energy trading, declaring the monthly trading curve of clean energy based on the typical output curve, determining the declared power and quotations in time slots, and at the same time, executing the time slot clearing mechanism in the market clearing stage, the invention can effectively enhance the market competitiveness of clean energy, promote the consumption of clean energy, and provide support for the synergistic development of clean energy and medium and long-term power trading.

### BRIEF DESCRIPTION OF THE FIGURES

FIG. 1 is a processing flow diagram of a block bidding method for promoting clean energy consumption based on the power trading platform according to the present invention.

FIG. 2 is a diagram of the module composition of a block bidding method for promoting clean energy consumption based on the power trading platform according to the present invention.

FIG. 3 shows a typical daily output curve of a clean energy unit in a specific implementation of the present invention.

### SPECIFIC IMPLEMENTATION

Embodiments of the present invention are described in further detail below in conjunction with the accompanying drawings.

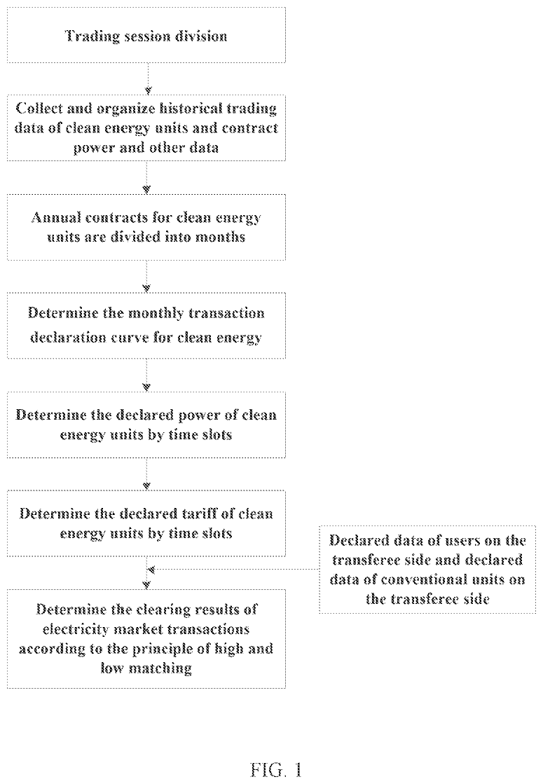

A block bidding method for promoting clean energy consumption based on the power trading platform, as shown in FIG. 1, comprising the following steps.

Step 1. dividing clean energy units to participate in power trading periods.

In this embodiment, the power trading sub-period can be determined with reference to the existing load peak and valley time division rules.

Step 2. collecting data on historical trading data and contracted electricity of clean energy units and predicting typical monthly generation curves of clean energy units.

In this embodiment, data for collecting historical trading data and contracted electricity of clean energy units: includes trading electricity, trading tariff level, and annual contracted electricity of clean energy units that have been signed.

Wherein, the annual contracted power is generally taken as a certain percentage of the annual power generation of the clean energy units, such as 65%, according to the rules of medium and long-term power trading.

Determine the annual signed contracts of clean energy according to the signed contracts, determine the monthly contracted power and tariff of users by time period and the contracted traditional energy according to the market trading situation in previous years; and predict the typical monthly power generation curve of clean energy units, where the prediction method can be selected according to different clean energy types and power output characteristics, such as trend extrapolation method, neural network prediction, reinforcement learning prediction, etc.

Step 3: Decompose the signed annual power contracts of clean energy units into months according to the annual typical curves of clean energy units.

The specific method of step 3 described is: through the historical annual renewable energy output, generate the annual clean energy unit typical curve, decompose the annual clean energy power contract to monthly according to the annual typical curve, and form the traded power for that month, the calculation formula as shown in formula (1).

$${q}_{j} = {Q}_{year} \cdot \frac{{q}_{o\_j}}{{{\sum }_{j = 1}}^{12} {q}_{o\_j}} \qquad ( 1 )$$

Where, qⱼ is the decomposition to electricity in month j; Q_{year} is the total annual contract; q_{o_j} is the generation capacity of typical curve in month j.

Step 4: Determining the monthly transaction declaration curve for clean energy units based on the typical monthly curve for clean energy units.

In this embodiment, the specific steps of step 4 include:

calculating the clean energy notation output coefficient at the point in time through the data center, allocating the monthly clean energy generation scale to time slots according to the clean energy unit output coefficient, and deriving a monthly time-slotted typical curve, and declaring the declared electricity of the clean energy market corresponding to the monthly typical curve.

(1) Calculation of clean energy unit output coefficients for each time point based on historical data.

The monthly power output coefficient by time period for the ith time point is calculated as shown in Equation (2).

$${w}_{i} = \frac{{\sum }_{i = 1}^{N} ( \frac{{P}_{i\_n}}{{P}_{i\_max}} )}{N} \qquad ( 2 )$$

wᵢ is the power factor of the clean energy unit; N is the number of historical data sets at time i; p_{i_n} is the power situation at time i of the nth set; P_{i_max} is the power maximum at time i of all sets.

(2) Through the existing generation power forecasting technology, forecasting the generation capacity of clean energy units for this month, and then subtracting the annual contract decomposition in step 3, which is the scale of clean energy unit output to be traded in this month, and then product the clean energy unit output coefficient with the scale of clean energy unit output for the month to get the typical curve of clean energy units for the month; its calculation formula is as in equation (3)

$${P}_{i} = P \cdot \frac{{w}_{i}}{{{\sum }_{i = 1}}^{I} {w}_{i}} \qquad ( 3 )$$

Where, Pᵢs the typical curve power value at time point i after decomposition of clean energy; P is the total installed capacity of clean energy units; I is the total number of time points.

(3) After generating the monthly typical curves of clean energy units, corresponding to the output of the monthly typical curves in each trading period, we can get the monthly trading declaration curves to be completed by clean energy units. Step 5: Determine the declared power of clean energy units for time-sharing transactions.

The specific steps of step 5 include.

(1) first calculating the clean energy trading power under the trading session as in equation (4).

$${q}_{t} = {\sum }_{i ∉} {P}_{i} \qquad ( 4 )$$

Where,

$$Q = {\sum }_{t = 1}^{T} {q}_{t} ;$$

T is the number of trading periods; qₜ is the clean energy trading power under the periods.

(2) Dividing the traded electricity into two parts as the regular part and as the incentive part, it has the relationship as shown in equation (5).

qₜ=aₜ+bₜ (5)

(3) Based on the collected user transaction data over time, constraint function equation (6) is established.

$$α = \frac{{a}_{t}}{{u}_{t}} \qquad ( 6 )$$

where a is the conventional market share of clean energy power, which is shown as a constant in the same month, and can be calculated by month according to the clean energy power generation in that month, and the market share of each time period in the same month remains consistent; uₜ is the market power demand of the customer side in time period t.

(4) Based on equations (5) and (6), the values of conventional and incentive power for clean energy units corresponding to different sub-periods can be solved.

Step 6. Considering the characteristics of clean energy output and determining the declared tariff of clean energy units in time slots.

The difficulty of clean energy consumption is that the clean energy output curve and the customer-side output curve are difficult to match completely. After step 5, the power of conventional part has been fully matched with the demand curve on the user side. Therefore, the conventional portion of electricity has the same utility as conventional energy in the process of market competition, and has more environmental characteristics, so it can declare the same price level as thermal power units. As for the incentive power, due to the difficulty of power consumption, it is necessary to declare a lower price relative to the market in the quotation process, so as to motivate users to adjust their own load curves to complete the consumption of clean energy.

The calculation method of the step 6 is divided into two price strategies, as shown in equation (7) and equation (8).

pₐΣPₘₐᵣₖₑₜ (7)

P_{b}=π•Σpₘₐᵣₖₑₜ (8)

Where, P_{a_t} is the regular power tariff; p_{b_t} is the incentive power tariff; p_{market_t} is the average market price; Σ is the floating point; λ is the price reduction factor, 0<π<1.

Step 7: Combining the declared data of users on the transferee side and the declared data of conventional units on the transferee side, the power trading platform realizes the transaction clearing by time periods according to the principle of “high and low matching”.

In this example, according to the pre-determined division of load peak and valley hours, the transaction will be cleared separately, and the transaction will be cleared by the following methods: the transferor will be ranked according to the declared price, and the lower price will be given priority to clear the transaction; when the price is the same, clean energy units will be given priority over traditional thermal units according to the principle of power cleanliness.

The same market players declare different time periods of power, electricity prices can be traded independently of each other, do not affect each other.

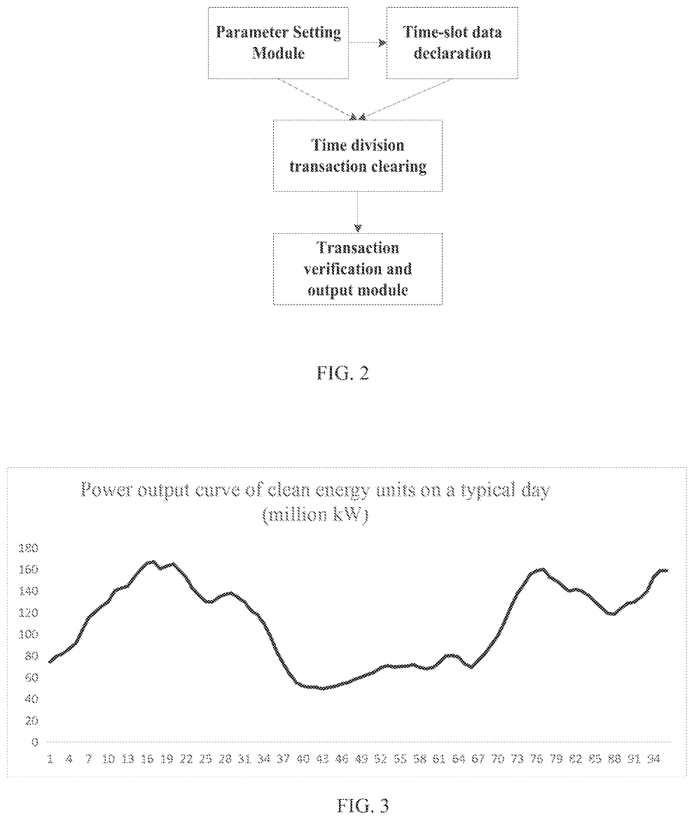

A power trading platform to promote clean consumption of power bidding and clearing system, as shown in FIG. 2, includes: parameter setting module, time-slot data declaration module, time-slot transaction clearing module and transaction verification and output module.

The parameter setting module is mainly used to set relevant parameters, such as annual contract power share, peak and trough time division, price reduction factor, market share of clean energy units, etc., which are set by market participants or trading centers.

The time-sharing data declaration module is used for market participants to declare time-sharing electricity and tariff data, and to complete the declaration of electricity trading data in conjunction with enterprises' own reality.

Accordingly, this module is connected with the parameter setting module and the time-sharing data declaration module, and can receive relevant parameters and transaction declaration data, and complete market clearing in multiple times according to the set peak and valley trading periods and get the clearing results in multiple times.

The transaction verification and output module is used to carry out the safety verification of power transactions and output the market transaction clearing results that pass the safety verification.

In this embodiment, time-slot data declaration module further comprising a trading time slot division module for dividing the clean energy units' participation in power trading time slots; an electricity trading history transaction data collection module for collecting electricity trading history transaction data, including electricity traded, electricity price level traded and electricity in the annual contract that has been signed by the clean energy units.

Annual contract decomposition module for decomposing the annual power contracts of clean energy units into months.

Monthly transaction declaration curve generation module used to generate monthly transaction declaration curves for clean energy units.

Time-slot declaration module, which is used to calculate the time-slot electricity of clean energy units and determine the timeslot declared electricity of clean energy units, taking into account the actual situation of the enterprises themselves.

The time-slot declaration tariff module, which is used to calculate the time-slot tariff of clean energy units and determine the time-slot declaration tariff of clean energy units, taking into account the enterprise's own reality.

In this implementation example, taking the trading data of a provincial power trading center as an example, the historical power generation level of a clean energy unit is 1.13139 ten-thousand kW.h, and the annual contract power factor is taken as 0.65. According to the market trading rules, the region's power trading peak section: 10:30-12:30, 17:30-20:00; flat section: 8:00-10:30, 12:30-17:30; valley section: 0:00-8:00, 20:00-24:00. The monthly power generation data and the decomposition to the monthly base power are shown in Table 1.

TABLE 1
Typical annual curves

| Monthly | | | | | | | |
|---|---|---|---|---|---|---|---|
| electricity | JANUARY | FEBRUARY | MARCH | APRIL | MAY | JUNE | JULY |
| Power generation | 98507 | 72193.88 | 109265.1 | 122124.5 | 127716.7 | 136001.3 | 130649.5 |
| (ten-thousand kW · h) | | | | | | | |
| Base power | 64029.36 | 46926.02 | 71022.33 | 79380.93 | 83015.84 | 88400.83 | 84922.14 |
| (ten-thousand kW · h) | | | | | | | |

| Monthly | | | | | |
|---|---|---|---|---|---|
| electricity | AUGUST | SEPTEMBER | OCTOBER | NOVEMBER | DECEMBER |
| Power generation | 117483.2 | 116401.2 | 99487.43 | 95569.36 | 88538.22 |
| (ten-thousand kW · h) | | | | | |
| Base power | 76364.07 | 75660.78 | 64666.83 | 62120.09 | 57549.84 |
| (ten-thousand kW · h) | | | | | |

The output curve of a typical day clean energy unit is shown in FIG. 3.

The traded tariffs and power volumes for the medium- and long-term time-sharing transactions between the user side and traditional energy power are shown in Table 2.

TABLE 2
Customer-side power transaction data

| | peak | Valley | Flat |
|---|---|---|---|
| Electricity turnover | 80203.31 | 40101.65 | 72182.97 |
| (ten-thousand kW · h) | | | |
| Sold electricity price | 0.65 | 0.48 | 0.32 |
| (yuan/kW · h) | | | |

The clean energy output coefficients were calculated for each time point, and the results are shown in Table 3.

TABLE 3
Calculation results of clean energy output coefficient

| Timeslot | 1 | 2 | 3 | 4 | 5 | 6 | 7 | 8 | 9 | 10 | 11 | 12 |
|---|---|---|---|---|---|---|---|---|---|---|---|---|
| Output | 0.44 | 0.48 | 0.49 | 0.52 | 0.55 | 0.62 | 0.69 | 0.72 | 0.75 | 0.78 | 0.84 | 0.85 |
| coefficient | | | | | | | | | | | | |
| Timeslot | 13 | 14 | 15 | 16 | 17 | 18 | 19 | 20 | 21 | 22 | 23 | 24 |
| Output | 0.86 | 0.91 | 0.96 | 0.99 | 1.00 | 0.96 | 0.98 | 0.99 | 0.95 | 0.91 | 0.85 | 0.81 |
| coefficient | | | | | | | | | | | | |
| Timeslot | 25 | 26 | 27 | 28 | 29 | 30 | 31 | 32 | 33 | 34 | 35 | 36 |
| Output | 0.78 | 0.78 | 0.80 | 0.82 | 0.83 | 0.80 | 0.78 | 0.73 | 0.71 | 0.66 | 0.59 | 0.50 |
| coefficient | | | | | | | | | | | | |
| Timeslot | 37 | 38 | 39 | 40 | 41 | 42 | 43 | 44 | 45 | 46 | 47 | 48 |
| Output | 0.43 | 0.38 | 0.33 | 0.31 | 0.30 | 0.30 | 0.30 | 0.30 | 0.31 | 0.32 | 0.33 | 0.35 |
| coefficient | | | | | | | | | | | | |
| Timeslot | 49 | 50 | 51 | 52 | 53 | 54 | 55 | 56 | 57 | 58 | 59 | 60 |
| Output | 0.36 | 0.37 | 0.39 | 0.41 | 0.42 | 0.42 | 0.42 | 0.42 | 0.43 | 0.41 | 0.41 | 0.41 |
| coefficient | | | | | | | | | | | | |
| Timeslot | 61 | 62 | 63 | 64 | 65 | 66 | 67 | 68 | 69 | 70 | 71 | 72 |
| Output | 0.44 | 0.48 | 0.48 | 0.47 | 0.43 | 0.41 | 0.45 | 0.49 | 0.54 | 0.59 | 0.66 | 0.75 |
| coefficient | | | | | | | | | | | | |
| Timeslot | 73 | 74 | 75 | 76 | 77 | 78 | 79 | 80 | 81 | 82 | 83 | 84 |
| Output | 0.82 | 0.87 | 0.93 | 0.95 | 0.96 | 0.91 | 0.90 | 0.86 | 0.84 | 0.85 | 0.84 | 0.81 |
| coefficient | | | | | | | | | | | | |
| Timeslot | 85 | 86 | 87 | 88 | 89 | 90 | 91 | 92 | 93 | 94 | 95 | 96 |
| Output | 0.78 | 0.75 | 0.71 | 0.71 | 0.74 | 0.77 | 0.78 | 0.80 | 0.84 | 0.92 | 0.95 | 0.95 |
| coefficient | | | | | | | | | | | | |

The generation capacity of the forecast month is 7880.05 ten-thousand kW.h, and the scale of clean energy output to be traded in that month is 275.82 ten-thousand kW.h. The typical curve of clean energy for that month is calculated according to Equation (2) as shown in Table 4.

TABLE 4
Typical clean energy curves for the month

| Timeslot | 1 | 2 | 3 | 4 | 5 | 6 | 7 | 8 | 9 | 10 | 11 | 12 |
|---|---|---|---|---|---|---|---|---|---|---|---|---|
| Power(kW · h) | 32.43 | 34.72 | 35.85 | 37.89 | 39.95 | 45.40 | 50.53 | 52.73 | 55.00 | 56.90 | 61.27 | 62.35 |
| Timeslot | 13 | 14 | 15 | 16 | 17 | 18 | 19 | 20 | 21 | 22 | 23 | 24 |
| Power(kW · h) | 63.09 | 66.80 | 69.85 | 72.45 | 73.03 | 70.19 | 71.24 | 72.07 | 69.36 | 66.65 | 62.07 | 59.29 |
| Timeslot | 25 | 26 | 27 | 28 | 29 | 30 | 31 | 32 | 33 | 34 | 35 | 36 |
| Power(kW · h) | 56.86 | 56.70 | 58.64 | 59.81 | 60.31 | 58.50 | 56.76 | 53.33 | 51.55 | 47.92 | 42.78 | 36.42 |
| Timeslot | 37 | 38 | 39 | 40 | 41 | 42 | 43 | 44 | 45 | 46 | 47 | 48 |
| Power(kW · h) | 31.64 | 27.40 | 24.03 | 22.68 | 22.26 | 22.18 | 21.58 | 22.12 | 22.61 | 23.57 | 24.15 | 25.44 |
| Timeslot | 49 | 50 | 51 | 52 | 53 | 54 | 55 | 56 | 57 | 58 | 59 | 60 |
| Power(kW · h) | 26.34 | 27.37 | 28.35 | 30.14 | 30.96 | 30.39 | 30.58 | 30.78 | 31.36 | 30.21 | 29.70 | 30.19 |
| Timeslot | 61 | 62 | 63 | 64 | 65 | 66 | 67 | 68 | 69 | 70 | 71 | 72 |
| Power(kW · h) | 32.23 | 34.87 | 35.08 | 34.39 | 31.58 | 30.22 | 33.11 | 35.77 | 39.40 | 43.07 | 48.45 | 54.67 |
| Timeslot | 73 | 74 | 75 | 76 | 77 | 78 | 79 | 80 | 81 | 82 | 83 | 84 |
| Power(kW · h) | 60.08 | 63.72 | 67.90 | 69.40 | 69.93 | 66.78 | 65.37 | 63.10 | 61.17 | 61.84 | 61.06 | 59.28 |
| Timeslot | 85 | 86 | 87 | 88 | 89 | 90 | 91 | 92 | 93 | 94 | 95 | 96 |
| Power(kW · h) | 56.65 | 54.43 | 52.10 | 51.85 | 54.25 | 56.22 | 56.66 | 58.59 | 61.18 | 66.85 | 69.46 | 69.51 |

Assuming that the price reduction factor π is 0.5, the trading tariff and electricity for each time period are solved according to equations (4)-(8) as shown in Table 5.

TABLE 5
Declared tariff and power situation

| | Peak | Valley | Flat |
|---|---|---|---|
| Base power (ten-thousand kW · h) | 9166.09 | 31123.46 | 10933.94 |
| Base tariff (yuan) | 0.51 | 0.51 | 0.51 |
| Conventional power (ten-thousand | 4935.59 | 2467.79 | 4442.03 |
| kW · h) | | | |
| Conventional electricity price (yuan) | 0.65 | 0.48 | 0.32 |
| Incentive power (ten-thousand | 0 | 14290.99 | 1445.47 |
| kW · h) | | | |
| Incentive tariff (yuan) | 0.325 | 0.24 | 0.16 |

For clean energy units, with lower declared tariff, the incentive power part can be given priority to “high-low matching” right, which makes it easier to complete the market matching and realize the effective market consumption of clean energy incentive power.

In this example, the priority incremental power consumption of clean energy is 157,364,600 kWh. If the transaction is completed according to its declared tariff, it can save 36,609,500 yuan of electricity cost for the transferee of the transaction, which realizes a win-win situation for both power generation side and electricity consumption side.

Those who skilled in the field should understand that embodiments of the present application may be provided as methods, systems, or computer program products. Thus, the present application may take the form of an entirely hardware embodiment, an entirely software embodiment, or an embodiment combining software and hardware aspects. Further, the present application may take the form of a computer program product implemented on one or more computer-usable storage media (including, but not limited to, disk memory, CD-ROM, optical memory, etc.) containing computer-usable program code therein.

The present application is described with reference to flowcharts and/or block diagrams of methods, devices (systems), and computer program products according to embodiments of the present application. It is to be understood that each process and/or box in the flowchart and/or block diagram, and the combination of processes and/or boxes in the flowchart and/or block diagram, may be implemented by computer program instructions. These computer program instructions may be provided to a processor of a general purpose computer, a specialized computer, an embedded processor, or other programmable data processing device to produce a machine such that the instructions executed by the processor of the computer or other programmable data processing device produce a device for implementing the functions specified in one process or multiple processes in the flowchart and/or one box or multiple boxes in the block diagram.

These computer program instructions may also be stored in a computer readable memory capable of directing a computer or other programmable data processing device to operate in a particular manner such that the instructions stored in such computer readable memory produce an article of manufacture comprising an instruction device that implements the function specified in one or more processes of a flowchart and/or one or more boxes of a block diagram.

These computer program instructions may also be loaded onto a computer or other programmable data processing device such that a series of operational steps are executed on the computer or other programmable device to produce computer-implemented processing such that the instructions executed on the computer or other programmable device provide the steps used to perform the functions specified in one or more processes of the flowchart and/or one or more boxes of the block diagram.

What is claimed is:

1. A block bidding method for promoting clean energy consumption based on the power trading platform, characterized by comprising the following steps:
step 1, dividing clean energy units to participate in power trading periods;
step 2. collecting data on historical trading data and contracted electricity of clean energy units and predicting typical monthly generation curves of clean energy units;
step 3. decomposing the signed annual power contracts of clean energy units into months according to the annual typical curves of clean energy units;
step 4. determining the monthly transaction declaration curve of clean energy units based on the typical monthly curve of clean energy units;
step 5. determining the declared power of clean energy units for trading in time slots;
step 6: determine the declared electricity price of clean energy units over time, taking into account the characteristics of clean energy output; and
step 7: combining the declared data of users on the transferee side and the declared data of conventional units on the transferee side, the power trading platform will realize the transaction clearing by time slots according to the principle of “high and low matching”.

2. The method according to claim 1, characterized in that the step 2 of the collection of clean energy unit historical transaction data and contract power data: including the transaction power, transaction tariff level, clean energy units have signed the annual contract power.

3. The method according to claim 1, characterized in that the specific method of step 3: through the historical annual renewable energy power output, generate annual clean energy units typical curve, according to the annual typical curve decomposition of clean energy annual power contract to the monthly, the formation of the month of the traded power, the calculation formula as formula (1) shows,
$${q}_{j} = {Q}_{year} \cdot \frac{{q}_{o\_j}}{{{\sum }_{j = 1}}^{12} {q}_{o\_j}} \qquad ( 1 )$$
where, qⱼ is the decomposed power in month j; Q_{year} is the total annual contract;
q_{o_j} is the typical curve generation in month j.

4. The method according to claim 1, characterized in that the specific steps of step 4 include:
(1) calculating the output coefficient of clean energy units at each time point based on historical data;
the monthly power output coefficient of the ith point of time is calculated as shown in equation (2):
$${w}_{i} = \frac{{\sum }_{i = 1}^{N} ( \frac{{P}_{i\_n}}{{P}_{i\_max}} )}{N} \qquad ( 2 )$$
wᵢ is the power factor of the clean energy unit; N is the number of historical data sets at time i; p_{i_n} is the power situation at time i of the nth set; P_{i_max} is the power maximum at time i of all sets;
(2) through the existing generation power forecasting technology, predict the generation capacity of clean energy units in this month, then subtract the annual contract decomposition in step 3, which is the scale of clean energy unit output to be traded in this month, and then product the clean energy unit output coefficient with the scale of clean energy unit output in this month to get the typical curve of clean energy units in this month; its calculation formula is shown in equation (3).
$${P}_{i} = P \cdot \frac{{w}_{i}}{{{\sum }_{i = 1}}^{I} {w}_{i}} \qquad ( 3 )$$
where, Pᵢs the typical curve power value at time point i after decomposition of clean energy; P is the total installed capacity of clean energy units; I is the total number of time points; and
(3) after generating the monthly typical curves of clean energy units, the monthly transaction declaration curves to be completed by clean energy units can be obtained by corresponding the output of the monthly typical curves in each trading period.

5. The method according to claim 1, characterized in that the specific step of step 5 comprises :
(1) first calculate the clean energy trading power under the trading session as equation (4):
$${q}_{t} = {\sum }_{i ∉} {P}_{i} \qquad ( 4 )$$
where,
$$Q = {\sum }_{t = 1}^{T} {q}_{t} ,$$
T is the number of trading periods; qₜ is the clean energy trading power under the periods;
(2) dividing the trading power into two parts as the regular part and bₜ as the incentive part, it has the relationship shown in equation (5):
qₜ=aₜ+bₜ (5)
(3)based on the collected user transaction data over time, constraint function equation (6) is established:
$$α = \frac{{a}_{t}}{{u}_{t}} \qquad ( 6 )$$
where, a is the conventional market share of clean energy power, which is shown as a constant in the same month, and can be calculated by month according to the clean energy power generation in that month, and the market share of each time period in the same month remains consistent; uₜ is the market power demand on the customer side in time period t; and
(4) based on Eq. (5) and Eq. (6), the values of conventional and incentive power for clean energy units corresponding to different sub-periods can be solved.

6. The method according to claim 1, characterized in that, characterized in that the calculation method of step 6 is divided into two price strategies, as shown in equation (7) and equation (8):
pₐ=ΣPₘₐᵣₖₑₜ (7)
P_{b}=π•ΣPₘₐᵣₖₑₜ (8)
where, p_{a_t} is the regular power tariff; p_{b_t} is the incentive power tariff; p_{market_t} is the average market price; σ is the floating point; π is the price reduction factor, 0<π<1.

7. The method according to claim 1, characterized in that the specific method of step 7 comprises:
according to the pre-determined load peak and valley time division, respectively, transaction clearing, transaction clearing method: the offer or in accordance with the declared price ranking, the lower price priority to clear the transaction; the same price, according to the principle of power cleanliness, clean energy units have priority over traditional thermal power units.

8. A block bidding system for promoting clean energy consumption based on the power trading platform, characterized by comprising: a parameter setting module, a time slot data declaration module, a time slot transaction clearing module, and a transaction verification and output module;
the parameter setting module is mainly used to set relevant parameters, such as annual contract power share, peak and trough time division, price reduction coefficient, market share of clean energy units, etc., which are set by the market participants or trading center;
the time-sharing data declaration module is used for market participants to declare time-sharing electricity and tariff data, and to complete the declaration of electricity trading data in conjunction with the enterprises' own reality; and
time-sharing transaction clearing module is used for market clearing, and this module is connected with parameter setting module and time-sharing data declaration module, which can receive relevant parameters and transaction declaration data, and complete market clearing by time slots several times according to the set peak and valley trading time slots, and get the time-sharing clearing results; and
the transaction verification and output module is used to carry out the safety verification of power transactions and output the market transaction clearing results that pass the safety verification.

9. The system according to claim 8, characterized in that the timeslot data declaration module further comprises a trading session division module for dividing clean energy units to participate in power trading sessions;
power trading history transaction data collection module, for collecting power trading history transaction data, including trading power, trading tariff level and annual contract power that has been signed by clean energy units;
annual contract decomposition module for decomposing the annual power contracts of clean energy units into months;
monthly transaction declaration curve generation module used to generate monthly transaction declaration curves for clean energy units;
time-slot declaration module, which is used to calculate the time-slot electricity of clean energy units and determine the time-slot declared electricity of clean energy units, taking into account the actual situation of the enterprises themselves; and
the module for calculating the block tariff of clean energy units and determining the block tariff of clean energy units, taking into account the actual situation of enterprises.
